(19) United States
(12) Patent Application Publication
(10) Pub. No.: US 2013/0022336 A1
(43) Pub. Date: Jan. 24, 2013

(54) TRANSMITTING APPARATUS AND RECEIVING APPARATUS

(71) Applicants: Shiro IWASAKI, Osaka (JP); Tokuo Nakatani, Osaka (JP)

(72) Inventors: Shiro IWASAKI, Osaka (JP); Tokuo Nakatani, Osaka (JP)

(21) Appl. No.: 13/551,026

(22) Filed: Jul. 17, 2012

(30) Foreign Application Priority Data
Jul. 19, 2011 (JP) 2011-158268

(51) Int. Cl. H04N 5/76

(52) U.S. Cl. 386/297; 386/E05.001

(57) ABSTRACT

A transmitting apparatus according to the present disclosure includes: a storage unit that stores series association information, the series association information associating a piece of series information with a name of the piece of series information and the piece of series information indicating association between a plurality of programs having a common characteristic; and a transmitting unit that transmits the series association information. A receiving apparatus according to the present disclosure includes:

a receiving unit that receives series association information, the series association information associating a piece of series information with a name of the piece of series information and the piece of series information indicating association between a plurality of programs having a common characteristic; and an output unit that outputs the name of the piece of series information based on the received series association information.

### BACKGROUND

1. Technical Field

The present invention relates to a transmitting apparatus and a receiving apparatus. More particularly, the present invention relates to a transmitting apparatus capable of transmitting information about programs, and a receiving apparatus capable of receiving information about programs. Additionally, the present invention relates to a transmitting method, more particularly to a transmitting method capable of transmitting information about programs.

2. Related Art

In recent years, receiving apparatuses capable of timer recording a series program have proliferated. The “series program” refers to a group of programs for when the programs are categorized by various conditions, i.e., a group of programs having a common characteristic in terms of the content of the programs.

For a receiving apparatus handling such a series program, there is, for example, a recording and playback apparatus described in JP 2010-56861 A. The recording and playback apparatus described in JP 2010-56861 A receives information about a series program and thereby grasps a copyright protection scheme of the series program.

An object of the present invention is to provide a transmitting apparatus, a receiving apparatus and a transmitting method each with a more improved user convenience in terms of recording and playback operation for a series program.

A transmitting apparatus according to the present invention includes a storage unit that stores series association information, the series association information associating a piece of series information with a name of the piece of series information and the piece of series information indicating association between a plurality of programs having a common characteristic; and a transmitting unit that transmits the series association information.

In addition, a receiving apparatus according to the present invention includes a receiving unit that receives series association information, the series association information associating a piece of series information with a name of the piece of series information and the piece of series information indicating association between a plurality of programs having a common characteristic; and an output unit that outputs the name of the piece of series information based on the received series association information.

In addition, a transmitting method according to the present invention is one at a transmitting apparatus. The transmitting method include storing in a storage unit series association information, the series association information associating a piece of series information with a name of the piece of series information and the piece of series information indicating association between a plurality of programs having a common characteristic; a control unit reading the series association information from the storage unit; and the control unit transmitting the read series association information to the external.

According to the present invention, by presenting the name of series information to a user, the user can more easily grasp the name of programs managed as a series program. By this, the convenience of the receiving apparatus improves more.

### BRIEF DESCRIPTION OF DRAWINGS

FIG. 1 is a block diagram showing the configurations of a recorder and a transmitting apparatus of the present embodiment;

FIG. 2 is a diagram showing series ID association information;

FIG. 3 is a diagram showing valid/invalid information of series IDs;

FIG. 4 is a diagram showing main/sub-level information of the series IDs;

FIG. 5 is a flowchart for describing the operation of receiving program information, series IDs, etc.;

FIG. 6 is a flowchart for describing operation for the case of making a series timer recording using EPG listings;

FIG. 7 is a diagram showing TV listings (program information) for selecting a program to be timer recorded;

FIG. 8 is a diagram showing a selection screen between a single timer recording and a series timer recording;

FIG. 9 is a diagram showing a selection screen between series timer recordings;

FIG. 10 is a diagram showing a list of series IDs for which a series timer recording has been made;

FIG. 11 is a flowchart for describing operation for the case of making a series timer recording through a start menu;

FIG. 12 is a diagram showing a start menu;

FIG. 13 is a diagram showing a main series selection screen;

FIG. 14 is a diagram showing a sub-series selection screen;

FIG. 15 is a flowchart for describing series ID update operation; and

FIG. 16 is a diagram showing display for the case in which a series ID has become invalid.

### DETAILED DESCRIPTION OF PREFERRED EMBODIMENT

An embodiment in which the present invention is applied to a transmitting apparatus and a recorder will be described with reference to the accompanying drawings.

### 1. Overview

In the present embodiment, a configuration for enabling all-at-once recording of a series program will be described. The “series program” refers to a group of programs for when the programs are categorized by various conditions, i.e., a group of programs having a common characteristic in terms of the content of the programs. For example, when the programs are categorized by genre, a group of programs belonging to “news”, “sports”, “drama”, etc., is a series program. For a drama that is broadcast, split into a plurality of parts, for example, all the episodes, from the first one to the last one, of the drama are a series program. In addition, for baseball game live programs, all programs of games played by a predetermined baseball team are also a series program. In addition, all programs in which a predetermined person appears may be a series program. The “series program” is hereinafter also simply referred to as a “series”.

A transmitting apparatus of the present embodiment transmits an Electronic Program Guide (EPG) as program information for identifying a program. The transmitting apparatus of the present embodiment provides pieces of program information of programs belonging to the same series program with identification information (hereinafter, referred to as a “series ID”) indicating that they are included in the same series, and then transmits program information. That is, programs provided with the same series ID belong to the same series. Thus, by a series ID, programs belonging to a series program associated with the series ID are identified. In addition, the transmitting apparatus of the present embodiment further associates a series ID with name information of the series ID and then transmits program information.

A recorder of the present embodiment receives program information and series IDs which are transmitted from the transmitting apparatus of the present embodiment, and performs all-at-once timer recording operation based on the series IDs. For example, when the transmitting apparatus of the present embodiment transmits program information where all pieces of program information of professional baseball programs are provided with the same series ID, the recorder of the present embodiment can identify all professional baseball programs by referring to the series ID provided to the programs and can make an all-at-once timer recording of the programs. In addition, based on name information associated with a received series ID, the recorder of the present embodiment can display the name of a series program associated with the series ID on an external television, etc.

### 2. Configuration

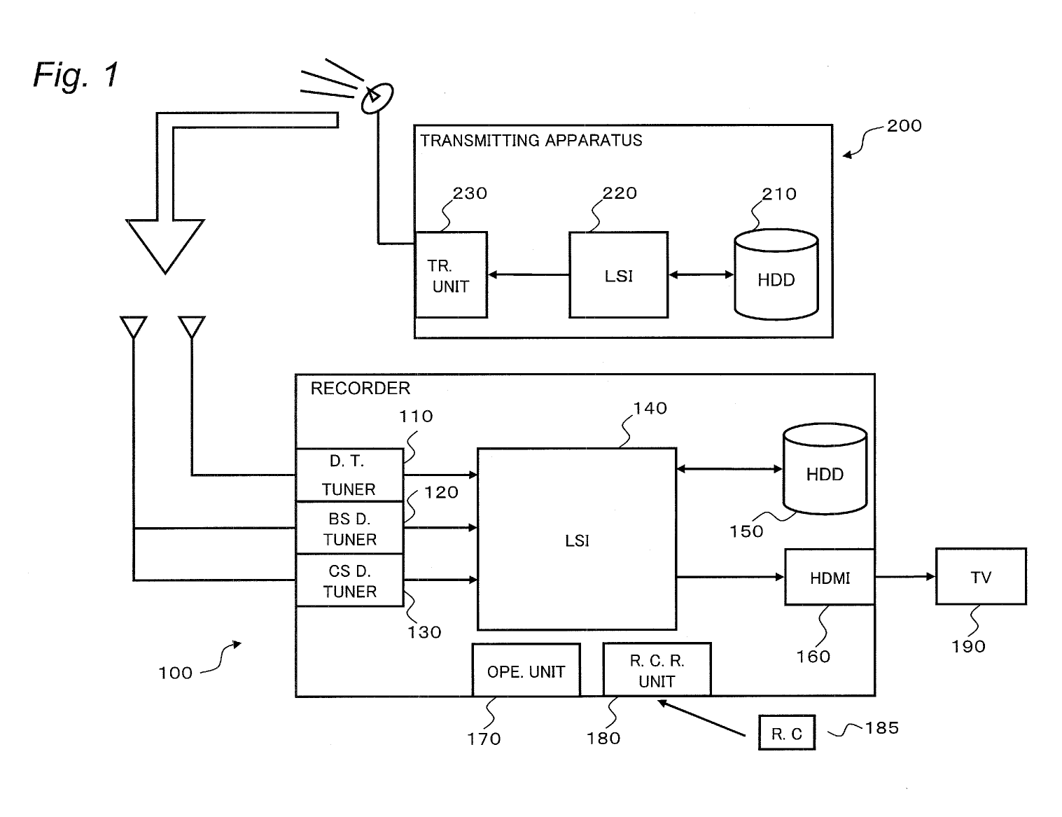

The configurations of a transmitting apparatus and a recorder of the present embodiment will be described with reference to FIG. 1. A transmitting apparatus 200 includes an HDD 210, an LSI 220, and a transmitting unit 230. The HDD 210 stores in advance program information where series IDs are associated with respective programs; and information about the series IDs. The “information about the series IDs” includes name information indicating names associated with the series IDs. A detail of the “information about the series IDs” will be described later. The LSI 220 reads the program information and the information about the series IDs from the HDD 210 and broadcasts these pieces of information through the transmitting unit 230. Here, the transmitting apparatus 200 broadcasts the program information by wire or wireless. Note that the transmitting apparatus 200 is installed in, for example, a broadcast station.

A recorder 100 includes a digital terrestrial tuner 110, a BS digital tuner 120, a CS digital tuner 130, an LSI 140, an HDD (Hard Disk Drive) 150, an HDMI (High Definition Multimedia Interface) 160, an operating unit 170, a remote control receiving unit 180, and a remote control 185.

The digital terrestrial tuner 110 of the recorder 100 receives, through an antenna, digital terrestrial broadcasts transmitted from the transmitting apparatus 200 in the broadcast station. The BS digital tuner 120 receives, through an antenna, BS digital broadcasts transmitted from the transmitting apparatus 200. The CS digital tuner 130 receives, through an antenna, CS digital broadcasts transmitted from the transmitting apparatus 200.

The LSI 140 includes an encoder, a decoder, an image processing block, a CPU, a built-in memory, etc. (these elements are not shown). The LSI 140 performs various types of processes on video data received by the digital terrestrial tuner 110, the BS digital tuner 120, or the CS digital tuner 130. Specifically, the LSI 140 performs encoding, decoding, image processing, etc., on the video data. The LSI 140 records compressed video data having been subjected to an encoding process, on the HDD 150. The LSI 140 performs a decoding process on the compressed video data stored on the HDD 150. The LSI 140 outputs the decoded video data to an external television 190, etc. through the HDMI 160.

The HDD 150 is a storage apparatus that stores data. The HDMI 160 is an interface for outputting video data and audio data to the external television 190, etc.

The operating unit 170 accepts user operation and inputs information about the operation to the LSI 140. The remote control 185 receives user operation and inputs information about the operation to the LSI 140 through the remote control receiving unit 180.

### 3. Information About Series IDs

As described above, the transmitting apparatus 200 transmits program information provided with series IDs and information about the series IDs. For the information about the series IDs, there are series ID association information, valid/invalid information, and main/sub-level information.

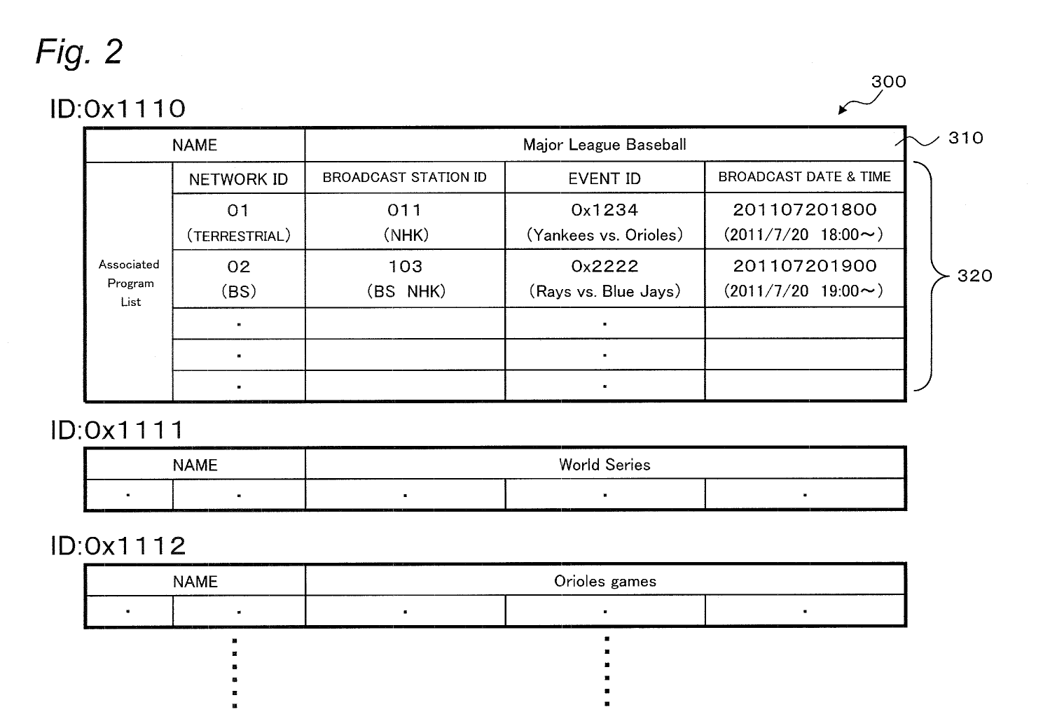

The series ID association information will be described with reference to FIG. 2. Series ID association information 300 is provided for each series ID. The series ID association information 300 includes name information 310 indicating the name of a series indicated by the series ID. In the example shown in FIG. 2, the name information 310 “Major League Baseball” is associated with the series ID “0x1110”.

In addition, the series ID association information 300 includes an associated program list 320. The “associated program list” is a list showing a list of programs included in program information (EPG) transmitted at substantially the same period, and assigned the same series ID. The associated program list 320 includes information indicating a network ID, a broadcast station ID, an event ID, and broadcast date and time. The “network ID” is an ID for distinguishing the types of broadcasts such as a digital terrestrial broadcast, a BS digital broadcast, and a CS digital broadcast. The “broadcast station ID” is an ID for distinguishing broadcast stations such as NHK and BS NHK. The “event ID” is an ID for distinguishing programs. The “broadcast date and time” is information indicating the date and time on which a program is broadcast. Such series ID association information 300 is provided for each series ID.

In the present embodiment, as a series ID, for example, 16-bit information (“0x0000” to “0xFFFE”) is used. Each series is assigned any of the pieces of 16-bit information. That is, in the present embodiment, 65535 (=2 to the 16th power−1) series can be distinguished. Note that “0xFFFF” is used as a series ID set to invalid. The ID “0xFFFF” is hereinafter referred to as an “invalid ID”. The validity/invalidity of series IDs will be described next.

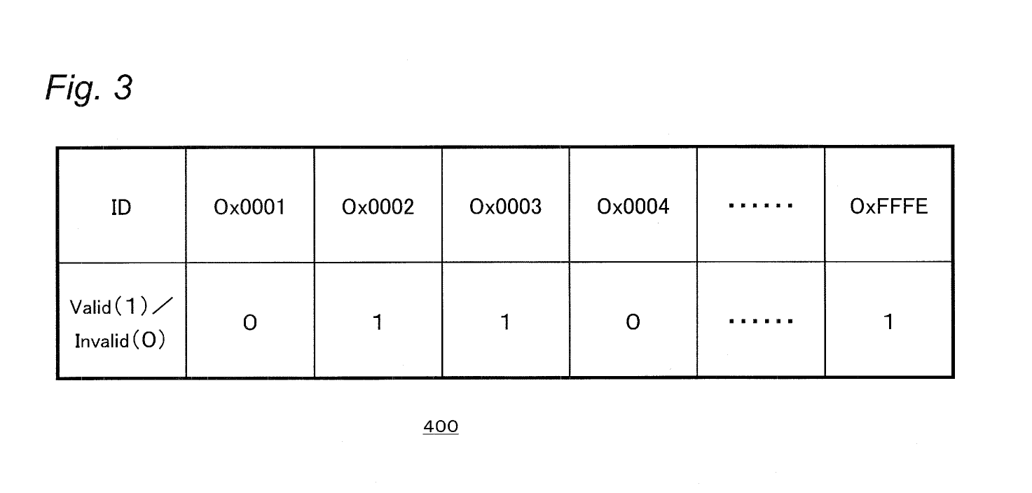

Valid/invalid information 400 will be described with reference to FIG. 3. The valid/invalid information 400 is information for associating a series ID with a flag indicating whether the series ID is valid or invalid. The valid/invalid information 400 includes all series IDs from “0x0000” to “0xFFE” and flags indicating whether each of the series IDs is valid or invalid. In the present embodiment, the flag “0” indicates invalid and the flag “1” indicates valid. Such valid/invalid information 400 is used so that a finite number of series IDs can be reused.

In the case of a scheme in which a series ID having been assigned to a series once is continuously used, every time a new series comes out, a new series ID needs to be assigned to the series. Repeating this eventually results in running out of series IDs. To solve such a problem, in the present embodiment the valid/invalid information 400 is used.

The transmitting apparatus 200 notifies the recorder 100 that a specific series ID has become invalid, by transmitting the valid/invalid information 400. Thereafter, the transmitting apparatus 200 associates a new series with the series ID having become invalid and can thereby transmit the series ID again as valid. By this, the transmitting apparatus 200 can associate a new series with a series ID having been associated with another series once and thus can reuse the series ID.

In addition, the transmitting apparatus 200 continues to transmit information indicating that a specific series ID is invalid, for a predetermined number of days (e.g., 100 days). This is because if the transmitting apparatus 200 transmits the valid/invalid information 400 only once, then when the recorder 100 has been unable to receive that one transmission, the recorder 100 cannot properly recognize that the series ID has become invalid. If the power to the recorder 100 is turned off at the time of transmission of the valid/invalid information 400, then such an event occurs. Continuous transmission of the information indicating that the series ID is invalid, for the predetermined number of days increases the chance that, when a certain series ID has become invalid, the recorder 100 can properly recognize that the series ID has become invalid.

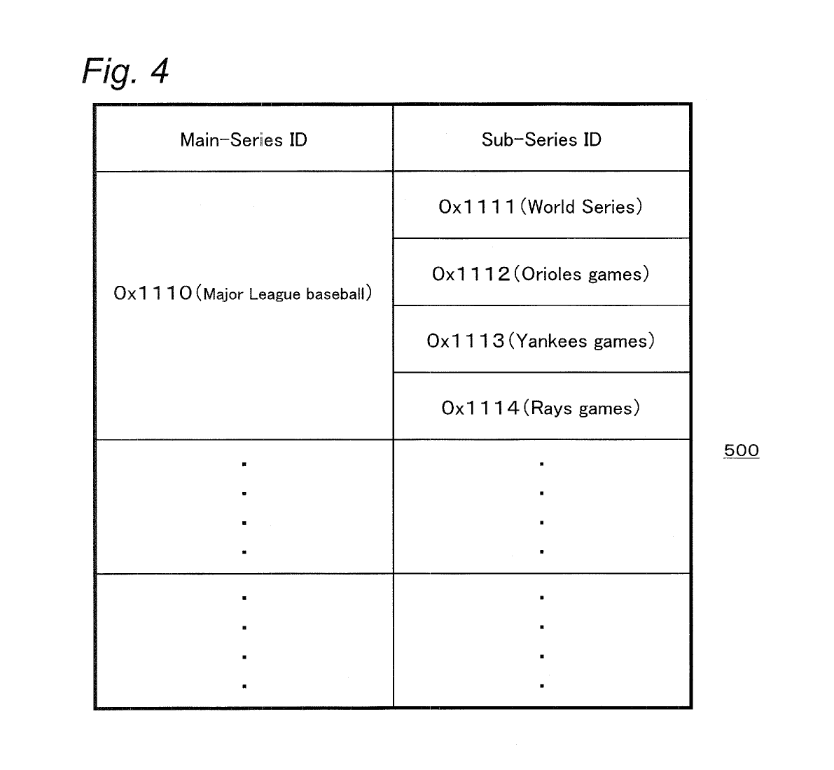

Next, main/sub-level information 500 will be described with reference to FIG. 4. As described above, in the present embodiment, a unique series ID is provided for each series. All series do not need to be at the same level. There is a case in which a certain series and another series have a containment relationship. For example, the relationship between “Major League Baseball” and “World Series” is considered. In this case, the relationship is such that “World Series” is contained in “Major League Baseball”. In addition, the relationship between “Major League Baseball” and “Orioles games” is such that “Orioles games” is contained in “Major League Baseball”. The main/sub-level information 500 is information indicating such a containment relationship between a plurality of series or a hierarchical structure. A higher-level series containing other series is called a “main series”. A lower-level series contained in a higher-level series is called a “sub-series”. Thus, the sub-series is a part of the main series.

### 4. Operation

4-1. Operation of Receiving Program Information, Series ID Association Information, etc.

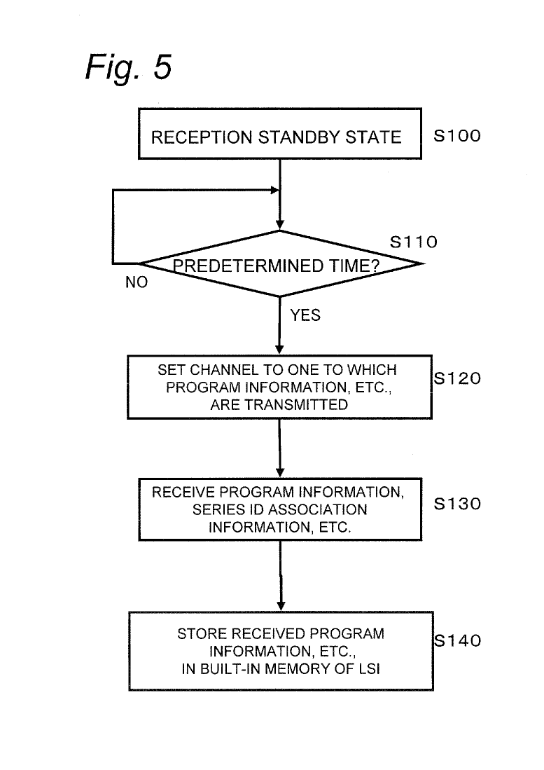

The operation of receiving program information, series ID association information 300, etc., by the recorder 100 of the present embodiment will be described with reference to FIG. 5. The recorder 100 is on standby, ready for reception of program information, etc., regardless of whether there is user operation (S100). In the reception standby state, the LSI 140 determines whether a predetermined time has come (S110). Specifically, the LSI 140 determines whether a timer included therein indicates a preset, predetermined time. If the LSI 140 determines that the predetermined time has come (YES in S110), then the LSI 140 sets a channel to be received on by the digital terrestrial tuner 110 to a channel to which program information, series ID association information 300, etc., are transmitted (S120). When the channel setting is completed, the LSI 140 receives program information, series ID association information 300, etc., through the digital terrestrial tuner 110 (S130). When the reception of the information is completed, the LSI 140 stores the received program information, series ID association information 300, etc., in the built-in memory of the LSI 140 (S140). By the information stored in the built-in memory, the recorder 100 can perform various types of control using the program information, the series ID association information 300, etc.

4-2. Series Timer Recording Operation (the Case of Making a Timer Recording from an EPG)

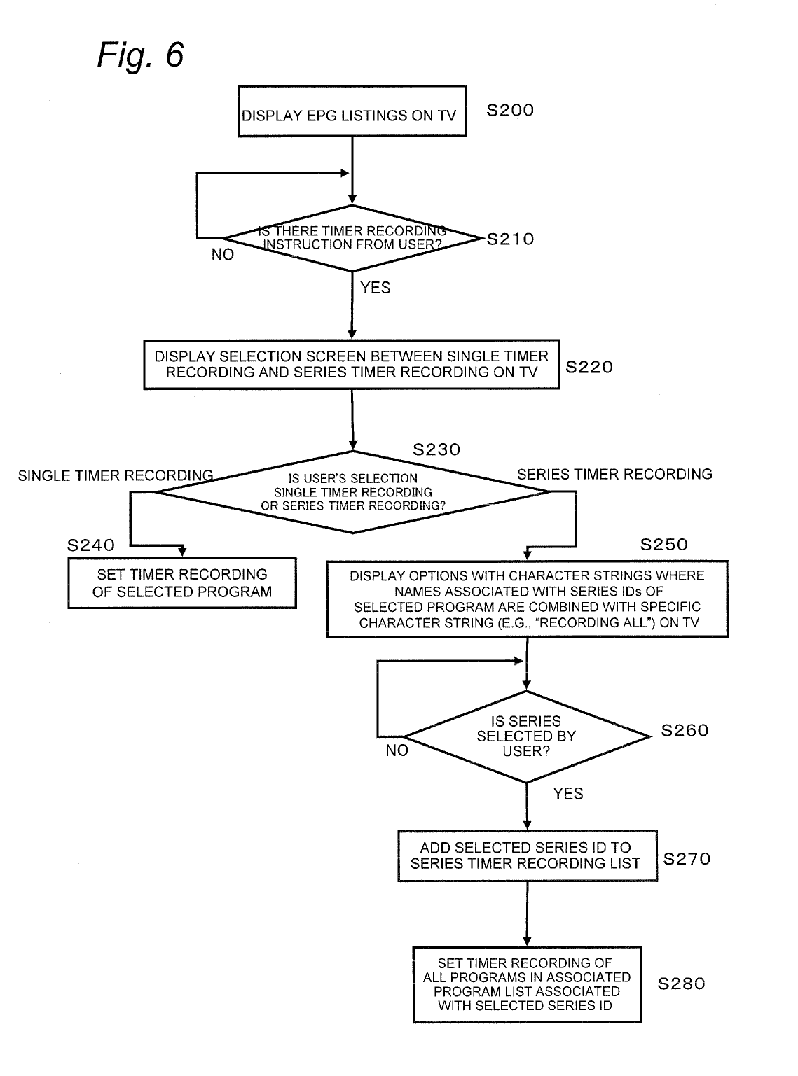

Next, the series timer recording operation of the recorder 100 will be described. Here, particularly, the case of making a series timer recording through an EPG will be described with reference to FIGS. 6 to 9. A “series timer recording” refers to that a timer recording of a series program provided with the same series ID is made all at once. On the other hand, making a timer recording of a single program is called a “single timer recording”.

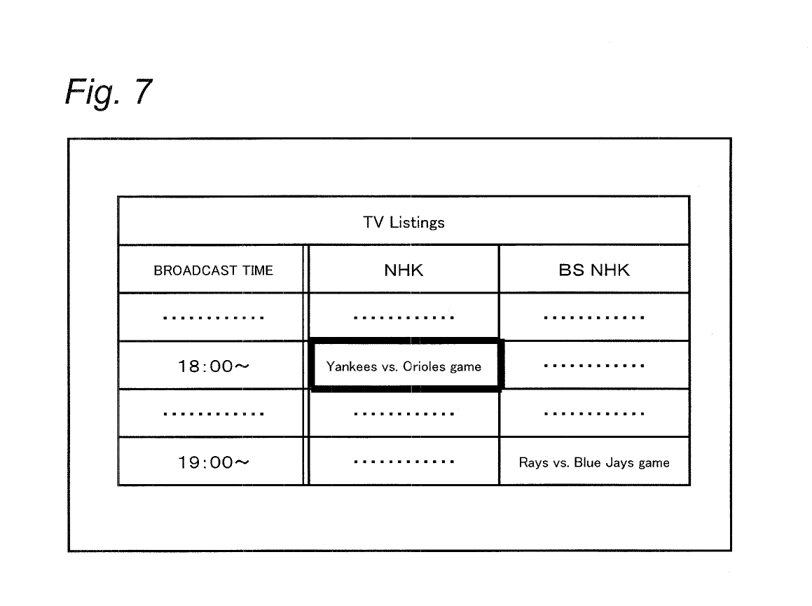

When the LSI 140 accepts an instruction to display an EPG from the user through the operating unit 170 or the remote control 185, the LSI 140 outputs program information (EPG) stored in the built-in memory to the external television 190 through the HDMI 160 to display TV listings such as those shown in FIG. 7 (S200). When the program information is outputted to the external television 190, the LSI 140 waits until accepting an instruction to make a timer recording of a program from the user through the operating unit 170 or the remote control 185 (S210). Note that the display apparatus 190 that displays the program information may be other than a television.

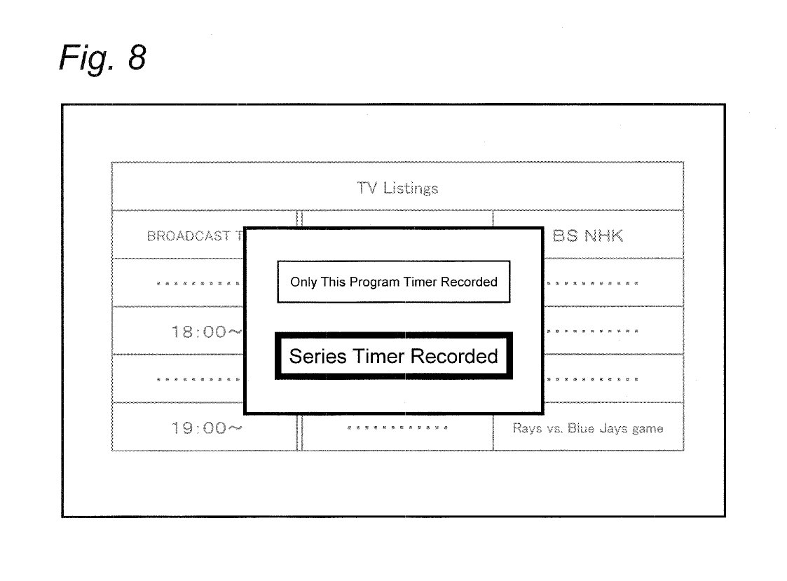

When the LSI 140 accepts an instruction to make a timer recording of a program from the user (YES in step S210), the LSI 140 outputs information about a selection screen that allows the user to select whether to make a single timer recording where only a selected program is timer recorded or a series timer recording including the selected program, to the external television 190 through the HDMI 160 (S220). Specifically, the LSI 140 outputs a selection screen such as that shown in FIG. 8, to the television 190. The user can select which timer recording to make by selecting either a single timer recording or a series timer recording by a cursor.

When the LSI 140 outputs the selection screen to the external television 190, the LSI 140 waits until the user selects either a single timer recording or a series timer recording (S230). If the LSI 140 determines that a single timer recording has been selected (“single timer recording” in step S230), then the LSI 140 makes a timer recording of only the program selected by the user (S240) and ends the timer recording operation.

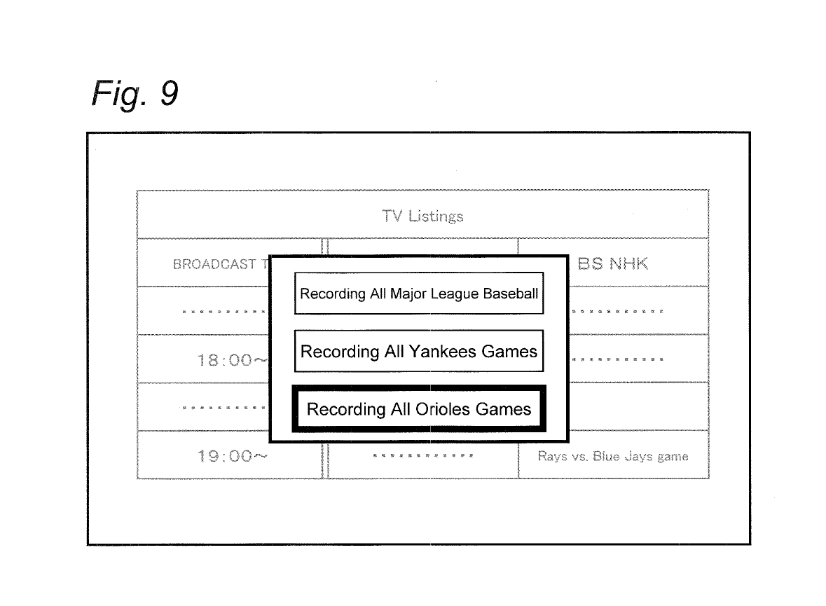

On the other hand, if the LSI 140 determines that a series timer recording has been selected (“series timer recording” in step S230), then the LSI 140 obtains name information associated with series IDs provided to the selected program, from series ID association information 300 (S250). Then, the LSI 140 creates new character strings where the obtained name information and a specific character string (in the present embodiment, the character string “recording all”) are combined. The LSI 140 outputs information indicating a selection screen including options which use the new character strings as their names, to the external television 190 through the HDMI 160 (S250). Specifically, the LSI 140 outputs a selection screen such as that shown in FIG. 9, to the external television 190. In this example, it is assumed that the program selected by the user is provided with three series IDs (an ID (0x1110) indicating “Major League Baseball”, an ID (0x1113) indicating “Yankees games”, and an ID (0x1112) indicating “Orioles games”). Thus, in this example, the following three options are displayed: “recording all professional baseball”, “recording all Yankees games”, and “recording all Orioles games”.

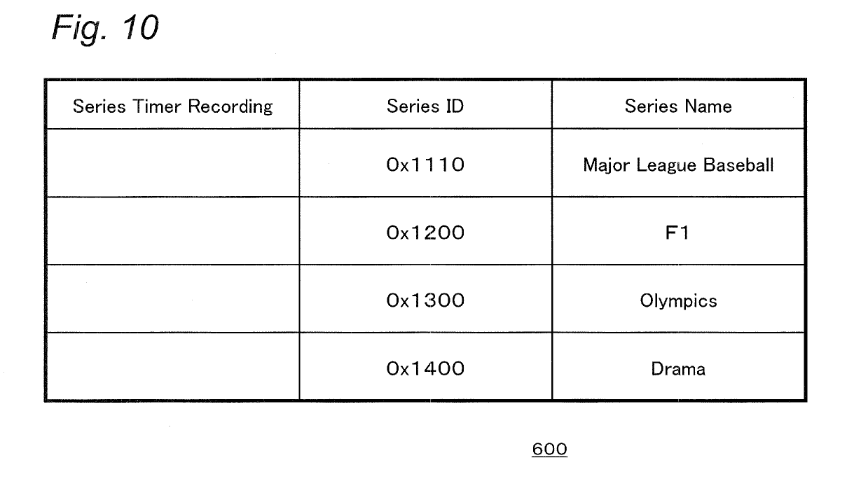

When the LSI 140 outputs the information indicating a series selection screen to the external television 190, the LSI 140 waits until a series selection is made by the user (S260). When a series selection is made (YES in step S260), the LSI 140 adds the selected series ID, as a target of a series timer recording, to a series timer recording list 600 such as that shown in FIG. 10 (S270). Note that when making a series selection, a plurality of series IDs may be selected. Note also that when displaying the series timer recording list 600, the series IDs themselves may be or may not be shown to the user through a screen of the television 190.

When the series ID is added to the series timer recording list 600, the LSI 140 makes a timer recording of programs included in an associated program list 320 in series ID association information 300 associated with the added series ID (S280).

4-3. Series Timer Recording Operation (the Case of Making a Timer Recording from a Start Menu)

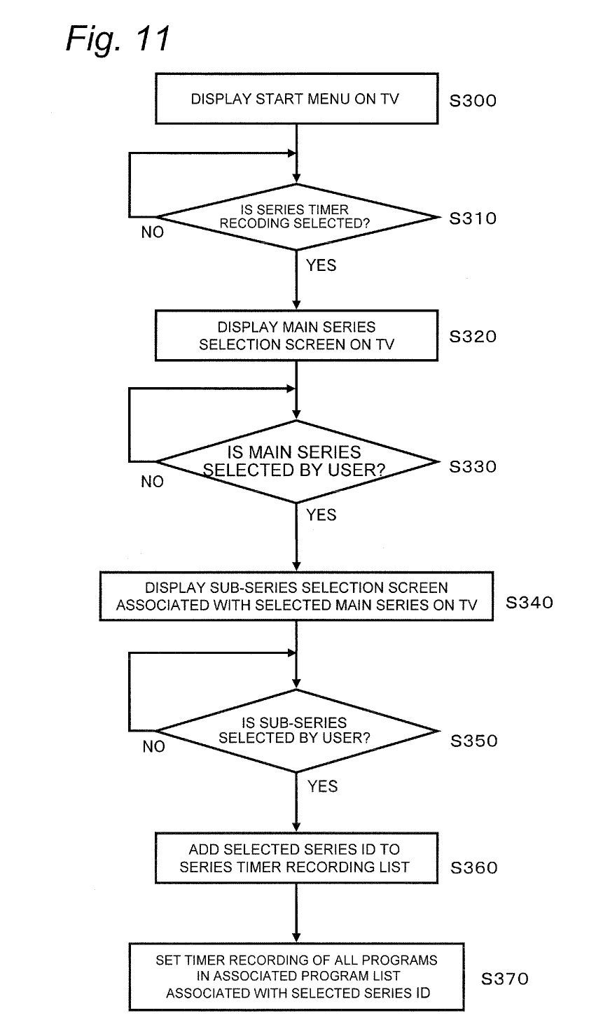

Next, the operation for the case of making a series timer recording from a start menu will be described with reference to a flowchart of FIG. 11. The “start menu” is an interface for accepting, by the recorder 100, an instruction from the user.

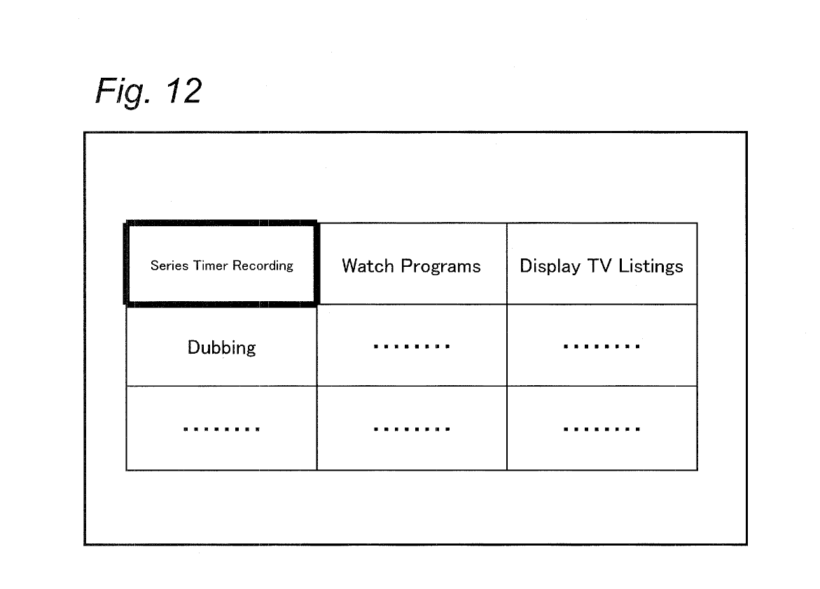

When the LSI 140 accepts an instruction to display a start menu screen form the user through the operating unit 170 or the remote control 185, the LSI 140 outputs information indicating a start menu screen such as that shown in FIG. 12, to the external television 190 through the HDMI 160 (S300). The start menu screen includes options such as “series timer recording”, “watch programs”, and “display TV listings”. By the user selecting any of the options, the recorder 100 performs operation associated with the selected option.

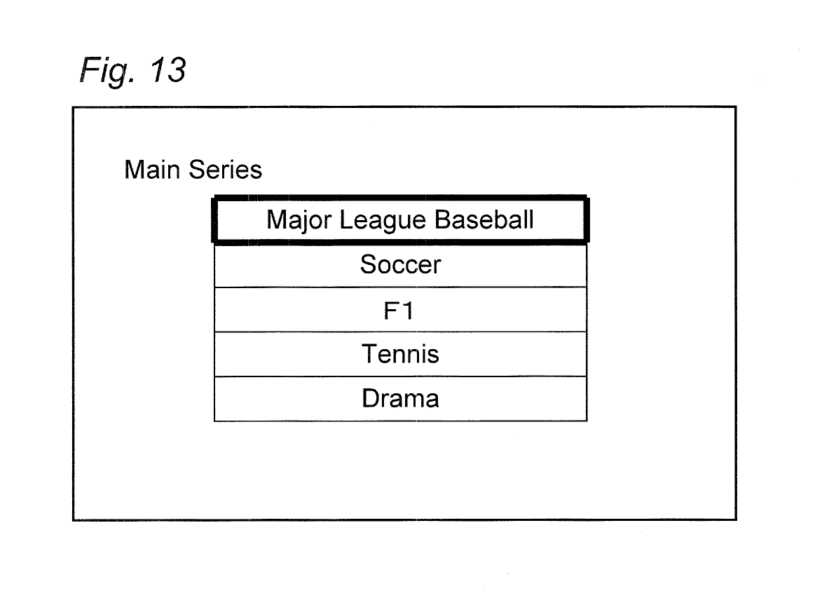

When the information indicating a start menu screen is outputted, the LSI 140 determines whether the option “series timer recording” has been selected by the user (S310). If the LSI 140 determines that any other option than “series timer recording” has been selected (NO in step S310), then the LSI 140 performs a function associated with the selected option and thereafter returns again to the operation of determining whether a series timer recording has been selected (S310). Description of functions associated with other options than “series timer recording” is omitted here. On the other hand, if the LSI 140 determines that a series timer recording has been selected (YES in step S310), then the LSI 140 outputs information indicating a main series selection screen such as that shown in FIG. 13, to the external television 190 through the HDMI 160 (S320). On the main series selection screen, the user can select one main series by moving a cursor by operating the operating unit 170 and/or the remote control 185.

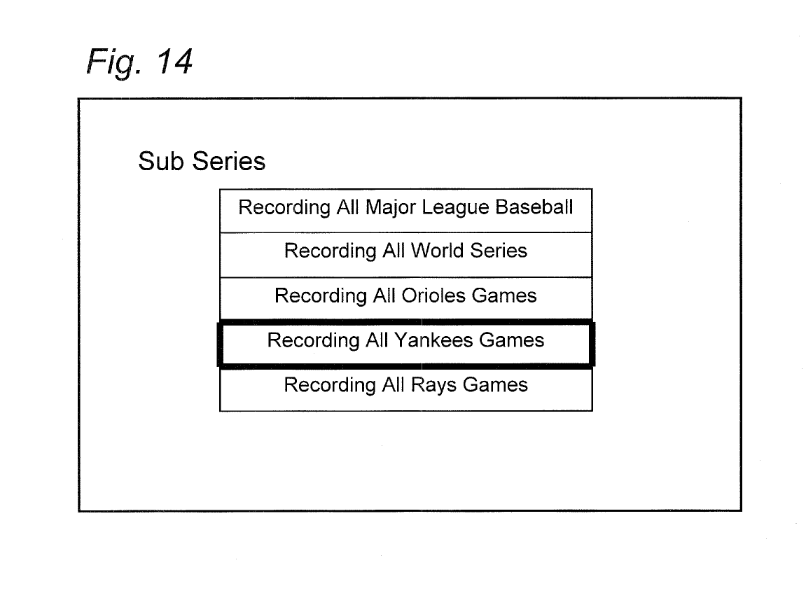

When the LSI 140 outputs the main series selection screen, the LSI 140 determines whether a main series has been selected by the user (S330). If the LSI 140 accepts a main series selection made by the user (YES in S330), then the LSI 140 outputs information indicating a sub-series selection screen such as that shown in FIG. 14, to the external television 190 through the HDMI 160 (S340). A list of sub-series displayed on the television 190 at this time is determined based on series ID level information such as that shown in FIG. 4. In this example, the sub-series “World Series”, “Orioles games”, “Yankees games”, and “Rays games” are associated at levels lower than the “Major League baseball” series.

Therefore, when “Major League Baseball” is selected as a main series, the options “World Series”, “Orioles games”, “Yankees games”, and “Rays games” are displayed in the list of sub-series.

When the LSI 140 outputs the sub-series selection screen, the LSI 140 determines whether a sub-series has been selected by the user (S350). When the LSI 140 accepts a sub-series selection, the LSI 140 adds the selected series, as a target of a series timer recording, to a series timer recording list 600 such as that shown in FIG. 10 (S360). When the LSI 140 adds a series ID to the series timer recording list 600, the LSI 140 makes a timer recording of programs described in an associated program list 320 included in series ID association information 300 provided to the added series ID (S370).

4-4. Series ID Update Operation

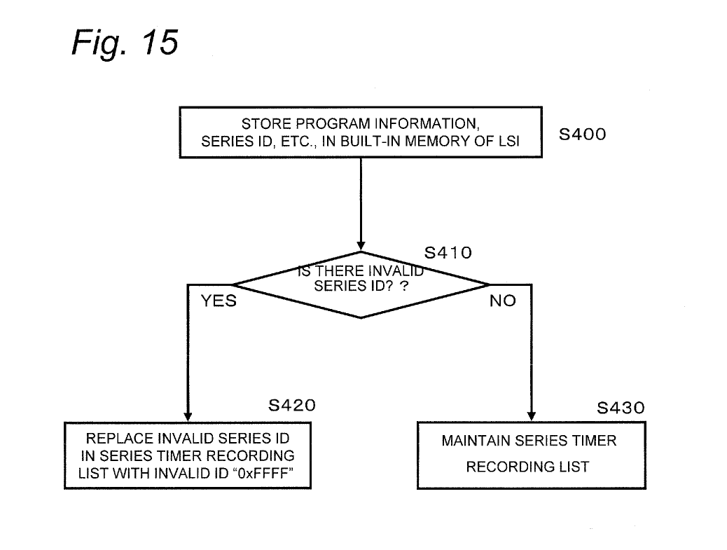

Next, series ID update operation will be described with reference to a flowchart of FIG. 15.

When the LSI 140 stores program information, information about series IDs, etc., in the built-in memory of the LSI 140, for example, as does in step 5140 of the flowchart of FIG. 5 (S400), the LSI 140 determines, based on received valid/invalid information 400 and a series timer recording list 600, whether there is an invalid series ID in the series timer recording list 600 (S410).

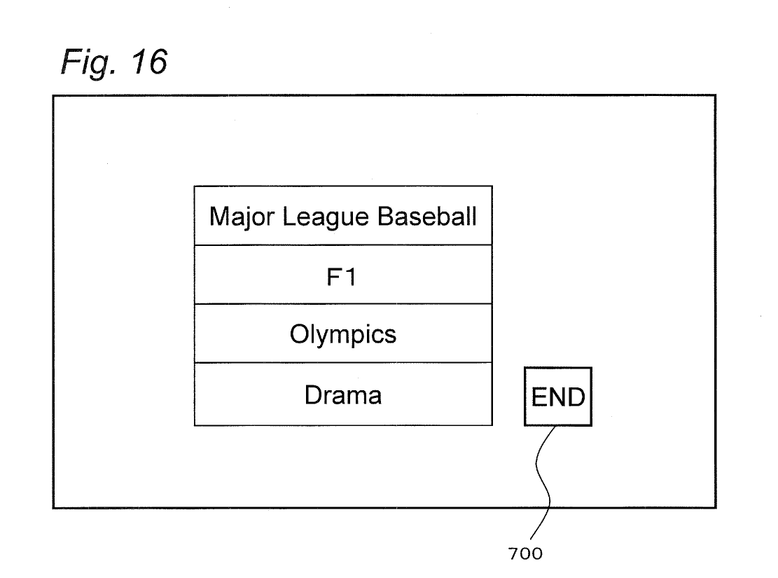

If the LSI 140 determines that there is an invalid series ID in the series timer recording list 600 (YES in step S410), then the LSI 140 replaces the invalid series ID in the series timer recording list 600 with an invalid ID (0xFFFF) (S420). Then, next time when the user displays a list of series timer recordings (series timer recording list 600), the LSI 140 allows the external television 190 to display a screen such as that shown in FIG. 16. That is, by providing display such as an icon 700, the LSI 140 can notify the user that a series ID has become invalid. In this example, since a series ID associated with a “drama” series is set to invalid, the icon 700 “end” is displayed on the right side of the option “drama”.

Note that the configuration is not necessarily the one shown in FIG. 16. For example, the configuration may be such that, next time when the user turns on the power to the recorder 100, the fact that a series of which a series timer recording has been made has become invalid is displayed by means of a pop-up screen.

On the other hand, if the LSI 140 determines that there is no invalid series ID (NO in step S410), then the LSI 140 maintains the series timer recording list 600 as it is without performing any process on the information on the series timer recording list 600 (S430).

As such, in the transmitting apparatus 200 of the present embodiment, series ID association information 300 includes name information 310 indicating the name of a series. By this, when one program is provided with a plurality of series IDs as in the example shown in FIG. 9, the recorder 100 of the present embodiment displays pieces of name information 310 associated with the respective series IDs as options. That is, the recorder 100 can output to the television 190 series represented by character strings instead of IDs which are simply a series of numbers, as a target of selection of an all-at-once timer recording. By this, options can be presented in an understandable form to the user.

In addition, series ID association information 300 transmitted by the transmitting apparatus 200 of the present embodiment includes, as shown in FIG. 2, information about the broadcast dates and times of programs. Thus, when the recorder 100 searches program information (EPG) for programs which are a target of a series timer recording during series timer recording operation, it is sufficient for the recorder 100 to do a search within a specific date and time range by referring to the information about broadcast dates and times. By doing a search only within a specific date and time range, search time can be reduced over the case of searching all programs in the program information (EPG). Thus, since the time required for series timer recording operation can be reduced, the convenience of the recorder 100 improves more.

In addition, when a series timer recording is selected by the user, the recorder 100 of the present embodiment adds a specific character string to name information 310 associated with a series ID provided to a selected program, and outputs the specific character string as an option. By this, the recorder 100 can inform the user about the description of series timer recording operation in a more understandable manner. For example, the recorder 100 adds the character string “recording all” to name information 310 provided to a series ID and outputs the character string. By this, the recorder 100 can allow the user to recognize that programs related to a series selected by the user can be timer recorded all at once. Note that without adding a specific character string, only name information 310 associated with a series ID may be displayed as an option.

In addition, when a series timer recording is selected by the user, the recorder 100 of the present embodiment adds a series ID which is a target of the series timer recording and name information 310 associated with the series ID to a series timer recording list 600. By this, even when program information transmitted from the transmitting apparatus 200 in a broadcast station, etc., has been changed, the recorder 100 can continue to make a timer recording of programs provided with a series ID for which a series timer recording is made.

### 5. Summary of the Present Embodiment

As described above, the transmitting apparatus 200 of the present embodiment includes the HDD 210 that stores series association information 300 which associates a series ID indicating association between a plurality of programs having a common characteristic, with name information 310 for the series ID; and the transmitting unit 230 that transmits the series association information 300.

In addition, the recorder 100 of the present embodiment includes the tuners 110, 120, and 130 that receive series association information 300 which associates a series ID indicating association between a plurality of programs having a common characteristic, with name information 310 for the series ID; and the HDMI 160 that outputs a name of the series ID based on the received series association information 300.

By such a configuration, the recorder 100 of the present embodiment presents name information 310 associated with a series ID instead of the series ID which is simply a series of numbers to the user, enabling to allow the user to more easily grasp the name of a series program indicated by the series ID. By this, the convenience of the recorder 100 improves more.

### 6. Other Embodiments

Although programs targeted by the above-described embodiment are moving images, the present invention is not limited thereto. The present invention can also be applied to programs with only audio.

In addition, although in the above-described embodiment the recorder 100 includes three tuners (the digital terrestrial tuner 110, the BS digital tuner 120, and the CS digital tuner 130), the present invention is not limited thereto. The recorder 100 may include only one of them or may include four or more tuners. In addition, the recorder 100 may include a receiving unit connectable to Internet, together with tuners, or instead of tuners, through which series association information 300 etc. can be received. A receiving unit connectable to Internet can be realized based on a module connectable to a wireless LAN or to a wired LAN.

In addition, although in the above-described embodiment an interface used by the recorder 100 to output video data and audio data to the external television 190 is the HDMI 160, the present invention is not limited thereto. The interface may be other than the HDMI 160. An RGB interface, a USB interface, etc., may be used. Alternatively, a radio interface may be used.

### INDUSTRIAL APPLICABILITY

The present invention can be applied to receiving apparatuses such as recorders, broadcast apparatuses that broadcast broadcast waves, etc.

What is claimed is:

1. A transmitting apparatus comprising:
a storage unit that stores series association information, the series association information associating a piece of series information with a name of the piece of series information and the piece of series information indicating association between a plurality of programs having a common characteristic; and
a transmitting unit that transmits the series association information.

2. The transmitting apparatus according to claim 1, wherein
the storage unit further stores associated program list information, the associated program list information being listing information about a plurality of programs provided with a same piece of series information, and
the transmitting unit transmits the associated program list information together with the series association information.

3. The transmitting apparatus according to claim 2, wherein the associated program list information includes information about broadcast dates of the respective programs included in the associated program list information.

4. The transmitting apparatus according to claim 1, wherein
the storage unit further stores level information, the level information indicating a hierarchical structure of pieces of series information, and
the transmitting unit further transmits the level information.

5. The transmitting apparatus according to claim 1, wherein
the storage unit further stores valid/invalid information, the valid/invalid information indicating validity/invalidity of the piece of series information, and
the transmitting unit further transmits the valid/invalid information.

6. A receiving apparatus comprising:
a receiving unit that receives series association information, the series association information associating a piece of series information with a name of the piece of series information and the piece of series information indicating association between a plurality of programs having a common characteristic; and
an output unit that outputs the name of the piece of series information based on the received series association information.

7. The receiving apparatus according to claim 6, wherein the receiving unit further receives associated program list information, the associated program list information being listing information about a plurality of programs provided with a same piece of series information.

8. The receiving apparatus according to claim 7, wherein the associated program list information includes information about broadcast dates of the respective programs included in the associated program list information.

9. The receiving apparatus according to claim 6, wherein the receiving unit further receives level information indicating a hierarchical structure of pieces of series information.

10. The receiving apparatus according to claim 6, wherein the receiving unit further receives valid/invalid information indicating validity/invalidity of the piece of series information.

11. A transmitting method at a transmitting apparatus comprising:
storing in a storage unit series association information, the series association information associating a piece of series information with a name of the piece of series information and the piece of series information indicating association between a plurality of programs having a common characteristic;
a control unit reading the series association information from the storage unit; and
the control unit transmitting the read series association information to the external.

12. The transmitting method according to claim 11, further comprising:
storing in the storage unit associated program list information, the associated program list information being listing information about a plurality of programs provided with a same piece of series information;
the control unit reading the associated program list information from the storage unit; and
the control unit transmitting the read associated program list information together with the read series association information to the external.

13. The transmitting method according to claim 12, wherein the associated program list information includes information about broadcast dates of the respective programs included in the associated program list information.

14. The transmitting method according to claim 11, further comprising:
storing in the storage unit level information, the level information indicating a hierarchical structure of pieces of series information;
the control unit reading the level information from the storage unit; and
the control unit transmitting the read level information to the external.

15. The transmitting method according to claim 11, further comprising:
storing in the storage unit valid/invalid information, the valid/invalid information indicating validity/invalidity of the piece of series information;
the control unit reading the valid/invalid information from the storage unit; and
the control unit transmitting the read valid/invalid information to the external.
